(19) United States
(12) Patent Application Publication
(10) Pub. No.: US 2012/0282423 A1
(43) Pub. Date: Nov. 8, 2012

(54) Joined Veneer Strip

(75) Inventors: Achim Möller, Dresden (DE); Andreas Wagner, Buhl (DE)

(73) Assignee: PADANA AG, Baar (CH)

(21) Appl. No.: 13/518,880

(22) PCT Filed: Dec. 22, 2010
(86) PCT No.: PCT/EP10/70508

§ 371 Date: Jun. 23, 2012

(30) Foreign Application Priority Data
Dec. 23, 2009 (DE) 10 2009 055 282.0

(51) Int. Cl. B27D 1/10; B32B 21/14; B32B 38/00; B32B 7/14; B32B 38/10; B32B 37/02

(52) U.S. Cl. 428/57; 156/154; 156/250; 156/220; 156/510

(57) ABSTRACT

The invention relates to veneer strips made of individual veneer layers (1), wherein adjacent veneer layers overlap (7) and comprise a joint (4) having a wedge-shaped cross-section in the region of the overlapping. The veneer layers are connected to each other by means of adhesive. The invention further relates to a method, to a device for performing the method, and to a use of the veneer strips.

The invention concerns a joined veneer strip, a method for joining or splicing veneers for producing closed, single-layer or multi-layer veneer strips, their use, and a device for performing the method.

Veneers are usually cut straight along the longitudinal edges by means of veneer guillotines, provided with a glue at these cut surfaces, subsequently fanned for avoiding adhesion of the veneer edges provided with glue, and, subsequently, in a veneer splicing machine, are glued to each other at the longitudinal edges to a veneer strip, as disclosed, for example, in G 90 11 185.0. Such veneer strips can be used for facing a support component such as an engineered wood panel.

This method requires a large number of working steps at a high machine expenditure. Processing of greatly undulated, bulging veneers is problematic. The undulations or bulges that are caused by specific structural features of the wood are pressed flat during cutting; after being removed from the clamping device of the veneer guillotine, these undulations spring back and cause curvatures at the initially straight cut edges. In this way, proper gluing in the veneer splicing machine is made difficult or impossible. By prior ironing of the veneers such undulations or bulges can be smoothed; however, this is successful against the undulations only up to a certain degree and requires a high additional expenditure.

For joining veneers, other gluing methods are also conventional, such as a zigzag-shaped gluing of a glue thread coated with a hot melt onto the joining areas or gluing on an adhesive paper strip. In this context, the undulation has a disadvantageous effect.

DE 00 0000948357 B discloses a method which circumvents the aforementioned disadvantages. To very thin veneer sheets of 0.1 mm thickness that must not mandatorily be cut straight, glue is applied and, subsequently, the sheets are placed in an scale-like arrangement onto the support component. The support component must be so compressible that the areas of the scale-like overlap is pressed into the support component in order to obtain a flat surface. Disadvantage in this connection are the required compressibility of the support component, which is not available to a satisfactory extent in conventional engineered wood panels, and also the joint that is present at the visible veneer edges and is wedge-shaped in cross-section; such joint is unacceptable for high-quality veneer surfaces. Moreover, the required complex glue application onto the individual veneer sheets is disadvantageous. Veneers with a thickness of <0.45 mm have moreover a significantly different visual appearance compared to veneers with greater thicknesses. The depth effect of the wood disappears and the haptic feel corresponds to that of wood substitute products. Processing of thicker veneers in accordance with this method is not conceivable because the already existing disadvantages would become even greater.

For pressing layered materials as well as pressing veneer strips onto support components such as engineered wood panels, different press pads have been proposed whose task it is to keep the applied pressure as constant as possible across the entire pressing surface, independent of thickness tolerances of the material to be pressed and imprecisions of the press. In A 274334, a press pad of a fabric is disclosed that has in the vicinity of the edge of the support component a step-wise increasing edge reinforcement in order to compensate the pressure drop at the edge. However, possibly existing thickness differences of the support component outside of the edge area are not taken into consideration. Moreover, the locally applied press power depends on the size of the respective thickness deviation. The fabric has also a bad thermal conductivity so that pressing at higher temperatures can be realized only with difficulty.

DD 264 189 as well as DD 255 130 disclose press pads of different compressible textile flat materials that, however, are able to act in a pressure-compensating fashion only within the limits disclosed in A 274334 and dissipate heat badly.

An ideal pressure compensation across the surface area to be pressed is achieved with known membrane presses that achieve the press power by means of a membrane loaded with compressed air. The membrane conforms to the contour of greatly profiled parts but is able to transmit heat only to a very limited extent so that correspondingly long pressing times are required. The technique is suitable for applying veneers to shaped parts that deviate greatly from a flat surface in their shape; however, a productive facing of panel-shaped parts is not possible with this technique.

For extending shorter veneer pieces, the so-called finger jointing is generally known in which the veneer ends to be joined are stamped to form a finger arrangement and to subsequently are joined with precise fit and adhesively connected. Also, repair of wood flaws is conventional where the flawed area is usually stamped out in an elliptical shape and subsequently filled in with a flawless veneer piece of the same shape. These techniques are complex and enable only a low quality of the finished product because the visual appearance is greatly impaired.

The object of the invention is to eliminate the disadvantages of the known prior art and to propose a joined single-layer or multi-layer veneer strip that can be inexpensively produced as well as a method for its manufacture and further processing, its advantageous use, and a device for performing the method.

This object is solved by the inventive features of claims 1, 5, 6, 8 and 9.

The veneer strip is comprised of a layer of veneer sheets with an average thickness of 0.2 mm to 2.5 mm wherein neighboring veneer sheets, respectively, in the contact area of the veneer sheets overlap each other in an scale-like arrangement with formation of a joint and, in the joint area, are connected to each other by a glue.

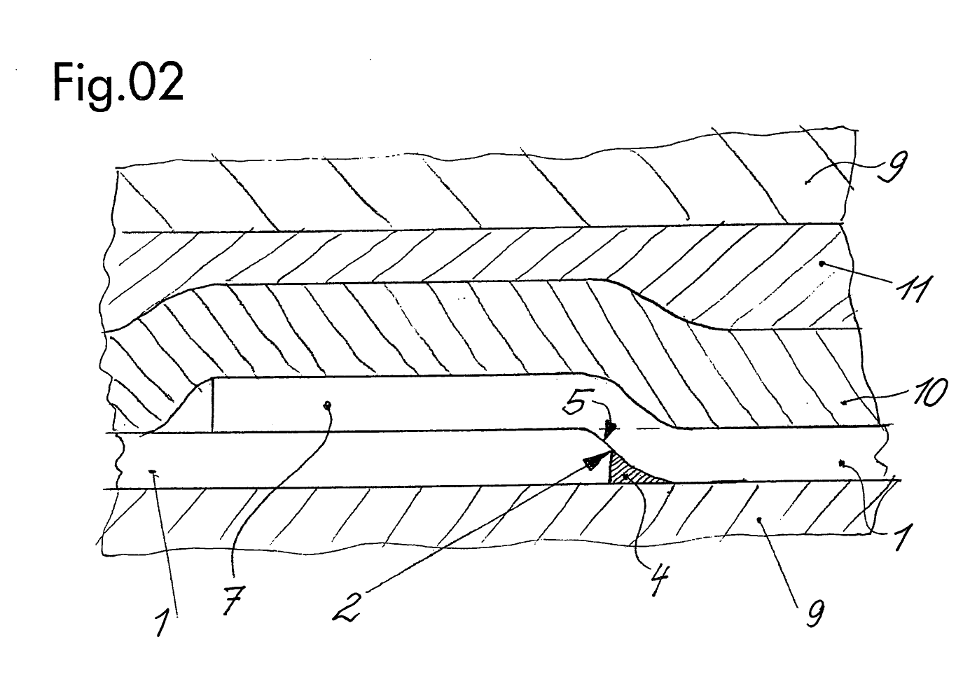

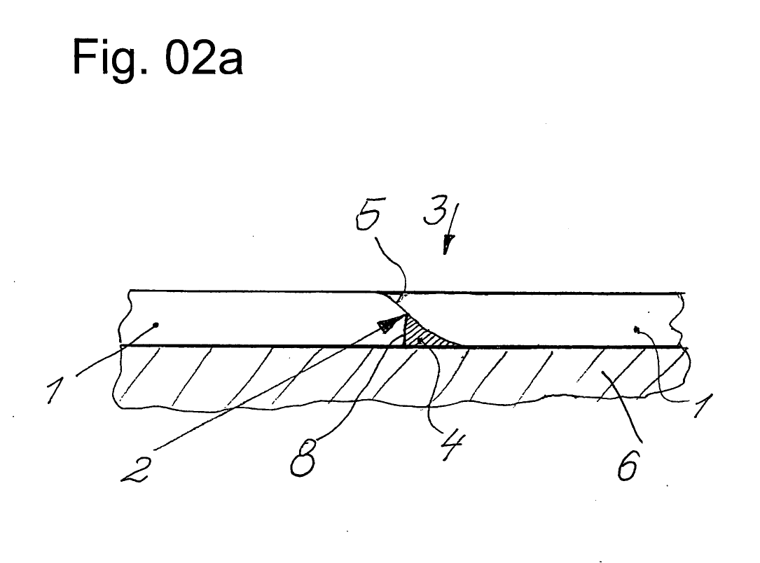

In this connection, the joint cross-section in the upper area has a tight joint and in the lower area a wedge-shaped joint that is filled with glue, as shown, for example, in FIG. 02a.

Preferably, veneer sheets with a thickness of 0.2 mm to 2.0 mm, particularly preferred with a thickness of 0.3 mm to 0.8 mm, are used.

As a glue, preferably a glue that cures, for example, a urea-formaldehyde resin glue, a melamine glue, a PVAc glue or a PUR glue are used.

The application of the innovative veneer strip is realized on a bending-resistant support or a support that is elastically deformable to a limited extent, such as a wood chipboard, OSB, MDF, plywood, aluminum panel or plastic panel. The manufacturing costs of the veneer strips are significantly reduced by elimination of the usual trimming of the otherwise butt-joined veneer strips at the longitudinal edges and of the complex gluing of the butt joints.

For adapting the veneer strip to the support, preferably a heated press pad of a soft stretchable mat and a layer of a plastic mass positioned there behind are provided wherein the plasticity of the plastic mass is reached at the adjustable pressing temperature.

The plastic mass flows upon generation of the press power from the projecting overlap areas proportionally to the areas of the support positioned adjacent thereto and keeps constant in this connection the press power in the overlap areas as well as in the other areas of the support component. The stretchable mat is pressed also against the edges of the overlap so that the overlapping veneer is applied with a very small radius about the edge of the veneer sheet lying underneath. In this way, in the upper area of the veneer cross-section a tight joint is produced and in the lower area a wedge-shaped joint filled with glue remains that is however always hidden. The mat, preferably of silicone with a minimal Shore hardness, as well as the plastic mass conduct the heat well from the press to the component.

After curing of the preferably heat-reactive glue, the veneered component is removed from the press. Subsequently, the overlap areas projecting from the component surface are removed, for example, by grinding or milling so that the component is provided with a continuous surface with tight veneer joints. The veneer is compressed by the pressing action at the prior overlap areas as well as in the planar areas so that a uniform surface structure of the veneer facing is ensured.

Such a veneer component is used for producing furniture, interior work elements, vehicle installations, or casings.

Components that are provided with a facing in accordance with the invention can be planar boards of wood-derived material such as chipboard, medium-density fiber board, or plywood. However, it is also possible to face flat or curved components with profiled edges, including the profiled edge, in accordance with the invention. For this purpose, the press pad follows the profile of the component.

The veneer sheets, in accordance with the invention, can be placed in overlapped arrangement along the longitudinal as well as the transverse edges wherein the transverse edge of the veneer sheet that is respectively lying underneath is preferably cut in a zigzag shape in the way of so-called known finger joints in order to obtain a slanted course of the transverse overlap. It is also possible to cut into a veneer sheet an opening, for example, with known stamping tools or also by means of waterjet cutting technique and to place on the circumferential edge in overlaying arrangement an appropriately sized veneer piece. In this way, partially undesirable characteristics such as knotholes can be repaired.

As an alternative to gluing the overlapped veneer sheets onto the support component and simultaneous pressing of the joint area, the veneer sheets alone can also be glued to each other by means of a press pad according to the invention and ground in a first step and, in a second step, can be glued onto the support component. For this purpose, glue must be applied to the edge of the veneer sheet to be overlapped. For gluing, in particular thermosetting curable glues, such as urea-formaldehyde resin glue or polyurethane glue, are suitable. Particularly advantageous is a slanted cut of this edge by means of a milling tool or a saw or another tools so that the overlap can follow the contour at a smaller angle relative to the veneer plane; the wedge-shaped joint area filled with glue is significantly smaller and the glued surface area is greater. In this way, an even better adhesion of the joined veneer sheets relative to each other is provided.

Such a slanted edge can be produced according to an advantageous variant already during the manufacture of the veneer in that the wood block that is damped in the veneer slicer has an outer surface that is oriented at a slant relative to the direction of the knife movement. The glue application can be realized before slicing at the slanted to outer surface of the wood block so that during the slicing process veneer sheets are produced that are already provided with glue.

Grinding off the overlap after the pressing action can be realized in a calibrating veneer grinding machine, optionally as an endless belt, in a direction transverse to the joint direction. Subsequently, the endless joined strip is cut to fixed dimensions.

The thus produced cut-to-size veneer strips can be glued in a conventional veneer press onto a support component wherein no press pad is required. Gluing can be done with the wedge-shaped joint area facing upwardly wherein this area upon subsequent grinding of the veneered component is removed so that the underlying joint is closed in a direction down to the support board. It is however also possible to position the wedge-shaped area so as to face the support component. In this connection, the surface must be ground less deep; the underlying wedge-shaped joint area remains covered. In case of light-colored wood types, these joint areas may shine through darkly. In this case, as is known in general in connection with veneers, a dye that matches the color of the wood can be added to the glue to make the joint area invisible.

The slanted cut and separate glue application of the veneer edge to be overlapped are also possible when directly gluing the overlapped veneer sheets onto the support component and simultaneously pressing the joint area. Advantageous in this connection is the tight glue joint down to a greater depth wherein here the risk of shining through of the adhesive is reduced also.

Instead of gluing the veneer strip according to the invention onto a support component, it is also possible to glue several veneer strips to each other so that a layered wood or plywood is produced.

Gluing the veneer sheets alone to each other has the advantage that the processes of veneer sheet joining and gluing onto a support component can be carried out temporally and/or locally separate from each other and that conventional veneer presses with rigid press platens can be used for veneer application.

The veneer can be processed according to the invention with a minimal wood moisture (approximately 12% moisture content) that is usually employed in veneer processing but also with a high wood moisture (up to 100% moisture content) as it exists directly after veneer production by slicing or peeling or with moisture contents that are in between.

When dry veneer is pressed, in certain types of wood undulations or bulges caused by the wood structure can occur during the drying process and during pressing they cannot be smoothed and may cause cracks. Also, grinding of undulated veneers that are joined alone presents great problems. Such undulations and bulges will not yet form at higher moisture contents of the wood so that this flaw can be eliminated by processing of the veneers according to the invention at higher wood moisture contents.

When simultaneously pressing the overlaps and the entire surface area on a support component, the high moisture of the veneer is partially absorbed by the support component, partially released to the environment after opening the press so that the veneered component finally reaches the usual compensation moisture that is conventional for use.

In this connection, a glue must be selected that is suitable for the respective moist gluing and the pressing time must be accordingly adjusted. Particularly suitable in this connection is a polyurethane glue that is adjusted especially for gluing moist wood.

When moist veneer in accordance with the invention is joined alone and when the veneer subsequently is to be calibrated in a grinding machine, a proportion of the veneer moisture must be maintained after leaving the press by appropriate covers, by moisture-saturated air and/or by immediately applying moisture thereafter. After grinding, drying to the desired final moisture content can be realized so that a short pressing time is achieved when pressing the veneer strip onto the support component.

When processing moist veneers, the presently conventionally used expensive and energy-intensive process of individually drying the veneer sheets becomes superfluous.

### EXAMPLE 1

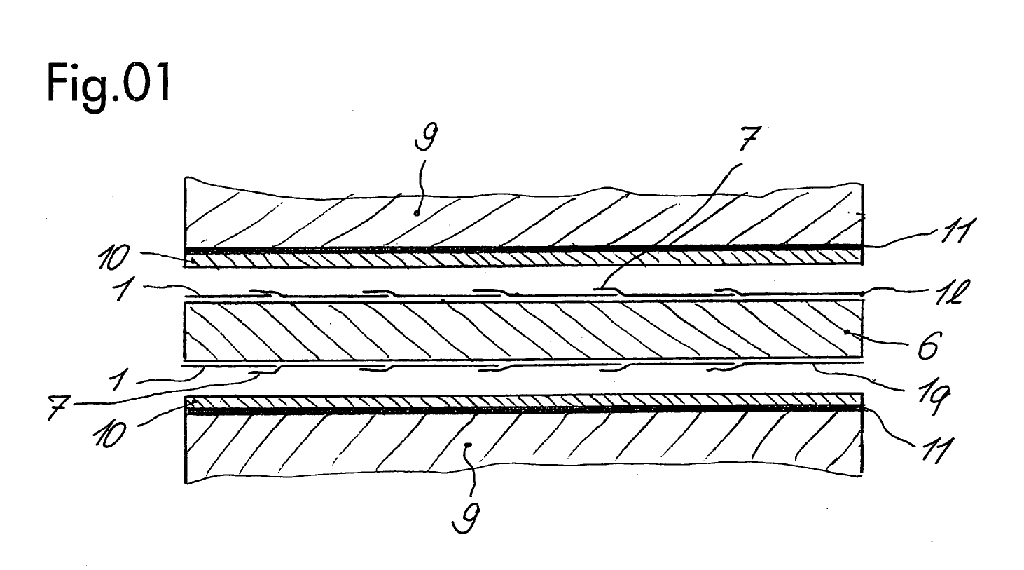

### FIGS. 01, 02 and 02a

Sliced veneer sheets of mahogany having a thickness of 0.55 mm, approximately a width of 150 mm and a length of 2,400 mm and a moisture contents of 8% are placed onto both faces of a chipboard as a support (6) having a thickness of 19 mm and provided with a urea-formaldehyde resin glue that has been dyed to a light color or a glue that acts similarly, wherein each veneer sheet (1) overlaps the respective adjacent one at the longitudinal edge (1) by 10 mm-20 mm. The thus prepared board is placed into a hydraulic press whose pressing platens (9), heated to 180 degrees Celsius, are provided with a press pad each that is comprised of a plastic mass (11) of polypropylene of a thickness of 2 mm and a soft mat (10) of silicone rubber having a thickness of 2 mm arranged on top. Upon closing of the press with a specific pressure of 0.6 N/mm² this pressing pad conforms to the surface contour with the overlap locations and transmits the adjusted press power uniformly onto all surface areas. In this connection, the longitudinal edge (11) of the veneer sheet (1) that is positioned underneath in the overlap area (7) is enclosed by the veneer (1) positioned above and compressed.

In this way, in the upper area of the veneer cross-section a tight joint (5) is created and in the lower area there remains a wedge-shaped joint (4) filled with glue.

The overlapping veneer area (7) that projects past the veneered width area by approximately 0.5 mm is then removed by grinding with a special grinding machine. This machine senses the width area of the board and grinds off only the overlap area flush with the width surface.

After a further generally applied smoothing grinding action of the entire board surface a veneered board (FIG. 02a) with closed veneer joints has been manufactured in accordance with a productive manufacturing process, such board being conventionally produced with significantly higher production costs today.

### EXAMPLE 2

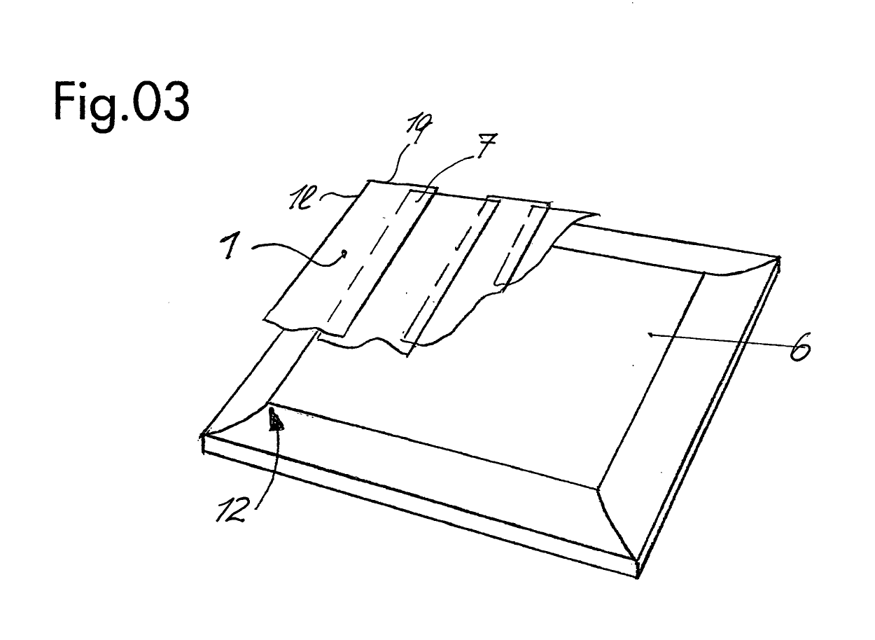

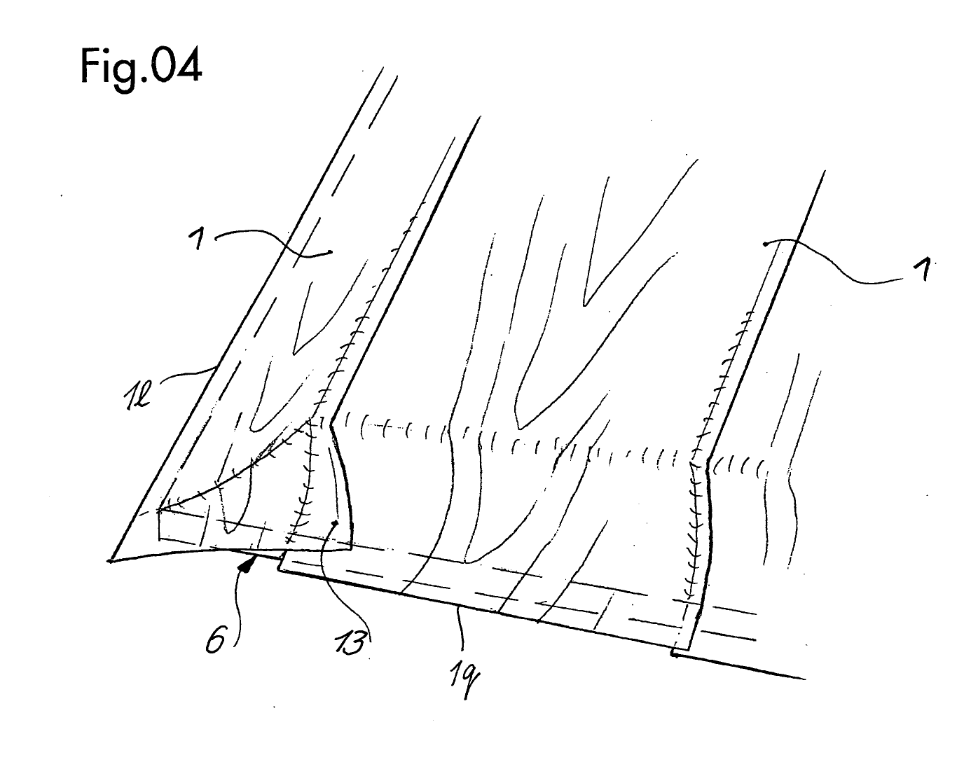

### FIGS. 03 and 04

A fiberboard of medium density and 25 mm thickness with the dimensions 500 mm×650 mm has a circumferentially extending profile in accordance with FIG. 3 as it is usually employed, for example, for door panels of furniture. This board as a support (6) is coated with a urea-formaldehyde resin glue known in furniture manufacture, or a similarly acting glue, and subsequently sliced oak veneer sheets with 10% moisture content and a thickness of 0.55 mm and a width of approximately 70 mm are placed thereon, wherein each veneer sheet (1) overlaps the respective neighboring one by 5-15 mm. The veneer sheets (1) are arranged such that one overlap area is positioned in the vicinity of a three-dimensionally shaped profile corner (12), respectively. The thus prepared board is placed into a hydraulic press having a top press platen heated to 190 degrees Celsius and matching the profile of the fiberboard (10) and provided with a press pad, comprised of a 3 mm thick layer of polyethylene and a soft silicone rubber mat on top of a thickness of 3 mm in analogy to Example 1. The corner areas are reinforced with a sheet metal that matches the contour and ensures reliable pressing of the sharp-edged corners. Upon closing of the press with a specific press power of 1.2 N/mm² this press pad conforms to the surface contour with the overlap areas and transmits uniformly the adjusted pressure onto all surface areas. The lower veneer edge that is positioned underneath in the overlap area is enclosed and compressed by the veneer positioned on top, as illustrated in example 1. In the corner area (12) of the profile, the veneers move in a wedge shape onto each other (13) during closing of the press and can therefore avoid largely the extreme tensions of a three-dimensional shaping so that the risk of cracks is minimized. The board is subsequently profile-ground so that the overlaps are removed and the entire surface is smoothed.

The result is a productively manufactured door panel whose profile depth is greater than in conventionally veneered parts of this kind.

### EXAMPLE 3

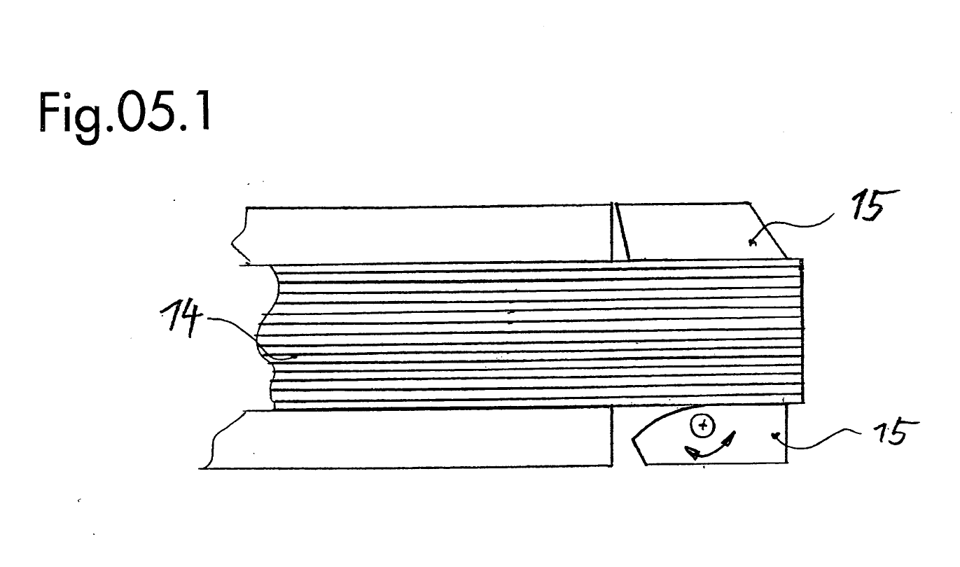

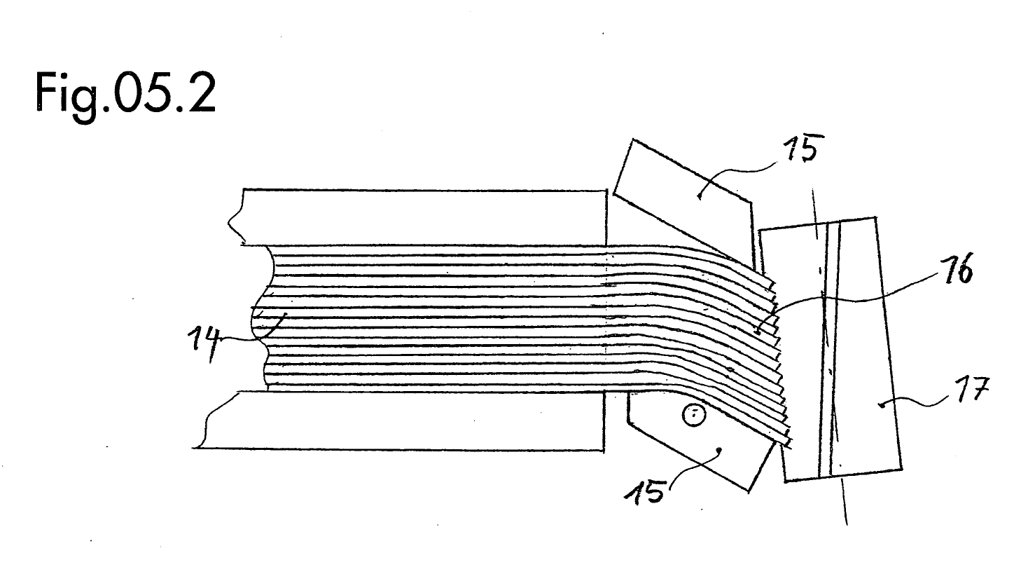

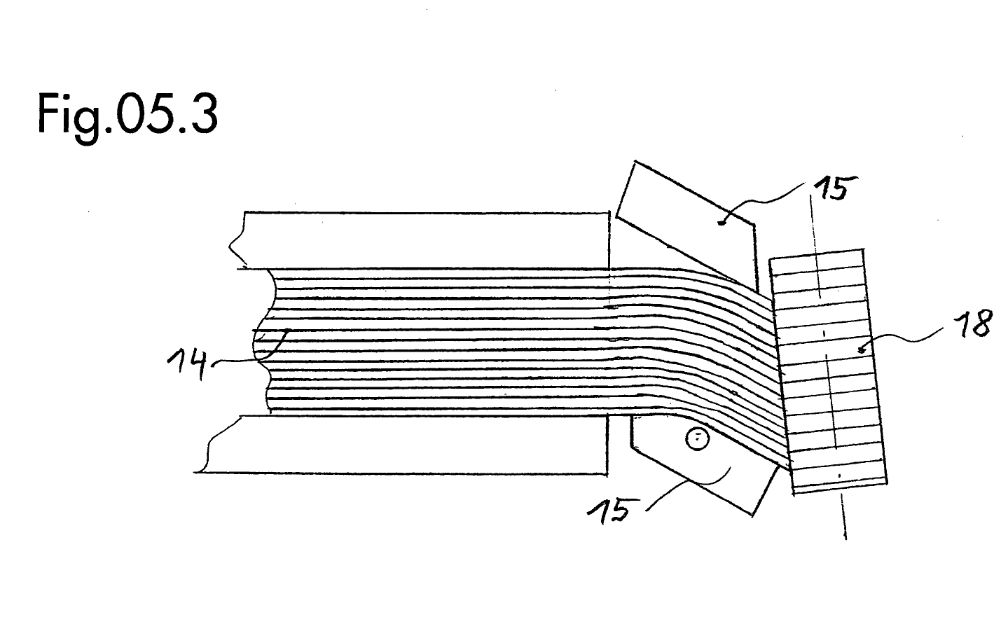

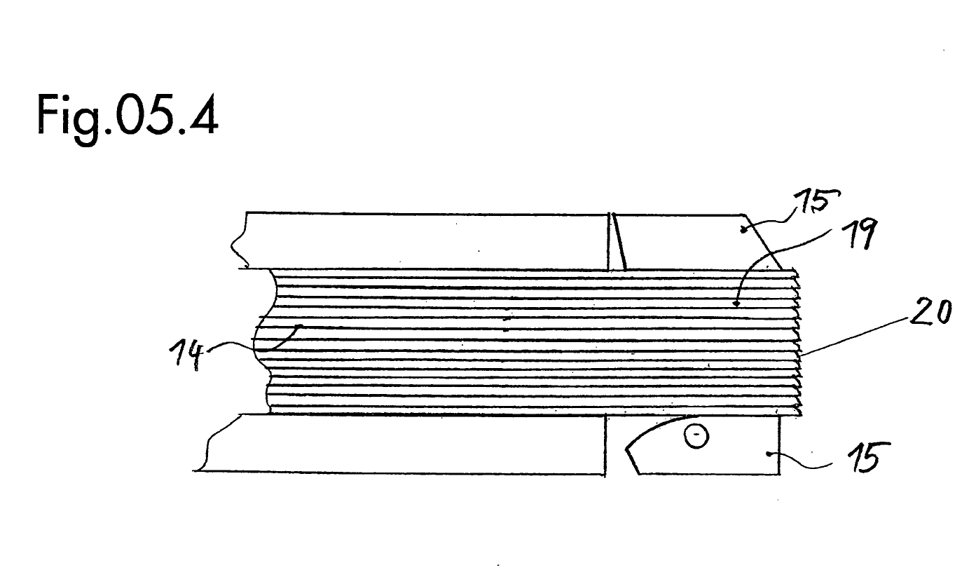

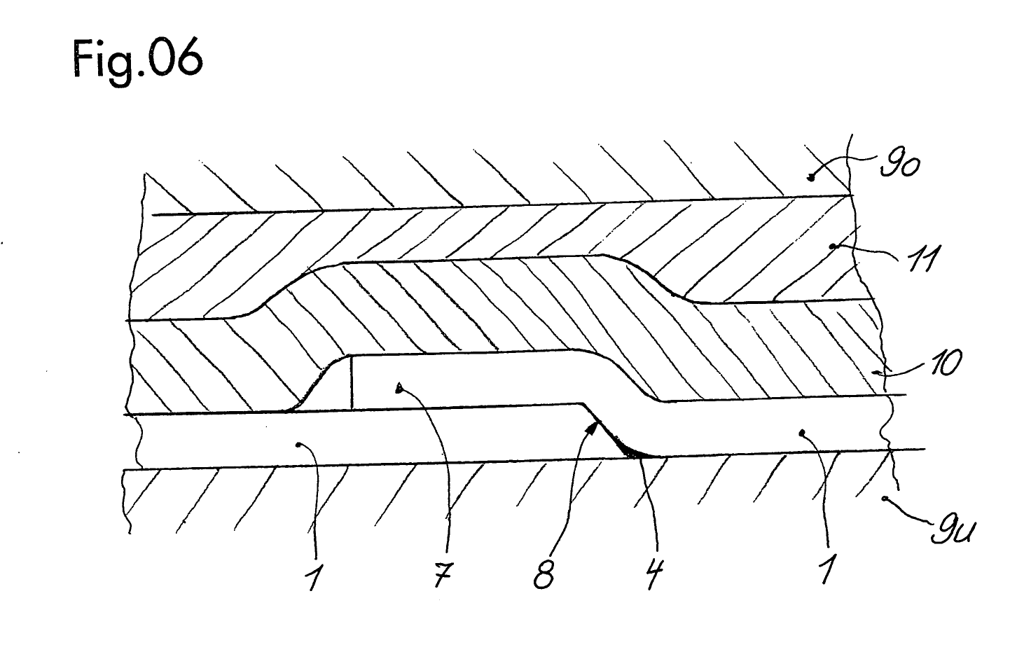

### FIGS. 05 and 06

Dried peeled birch veneer of a thickness of 0.53 mm, a length of 2.5 m and a width of 400 mm is cut straight in a veneer stack (14) of a height of approximately 25 mm along a longitudinal edge by means of veneer guillotine, is fanned (16) in a slanted arrangement by bending of the pack in a bending device (15), is milled (17) to a planar shape along the slanted surfaces, and, by means of a glue application roller (18), is provided with a urea-formaldehyde resin glue or a similarly acting glue, and subsequently is returned into the initial position (19) by bending back. In this way, the veneer sheets (1) are provided with a beveled, outwardly slanted edge (8) with applied, in the meantime dried, glue that is spaced from the neighboring edges provided with glue.

These veneer sheets are placed, optionally after a short storage time, in overlapped arrangement to form an endless veneer strip wherein the edges (8) with applied glue are arranged underneath the overlap area (7), respectively, that has approximately a width of 10-30 mm. This veneer strip is then transported by means of a transport belt into a press operating in a cycled fashion and having in working direction a length of 1.5 m, whose rigid bottom press platen (9u) is heated to 120 degrees Celsius and whose top press platen (9o) is provided with a press pad (10, 11) in accordance with the Example 1. Upon pressing with parameters in analogy to Example 1, the overlapping veneer area (7) conforms largely to the slant (8) with applied glue and in this way joins the two veneer sheets (1) to each other, respectively.

The thus formed endless veneer strip is coiled at the outlet of the press with a total length of 400 meters and stored, subsequently is ground to a uniform thickness of 0.5 mm as an endless strip in a known calibrating grinding machine at the overlapped areas transversely to the wood fiber direction, and subsequently, by means of a veneer clipper, is cut to a size of 1.25 m. The thus produced so-called standard-dimension veneers according to known technology are glued with a glue that is dyed to have a light color onto chipboard and subsequently again ground across the entire surface area. These veneered chipboards can be used universally.

### EXAMPLE 4

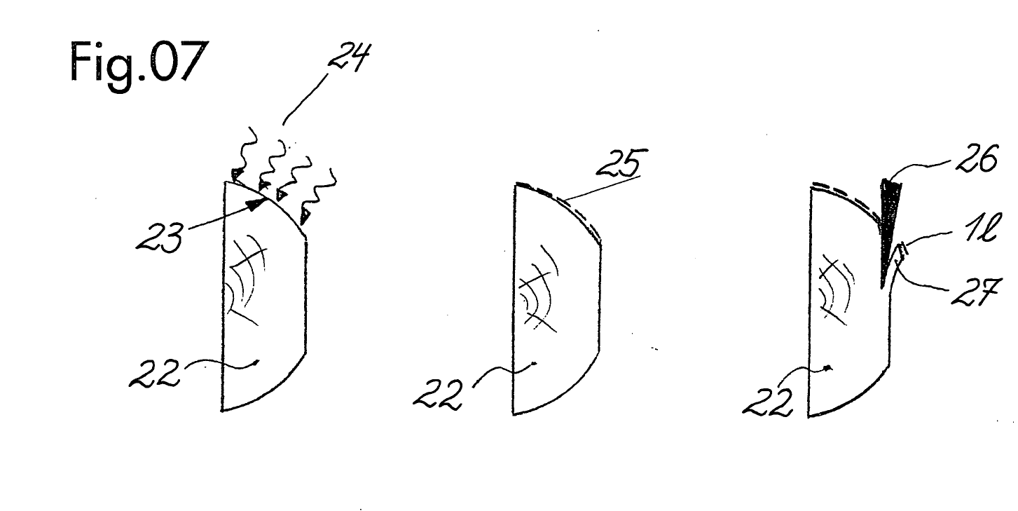

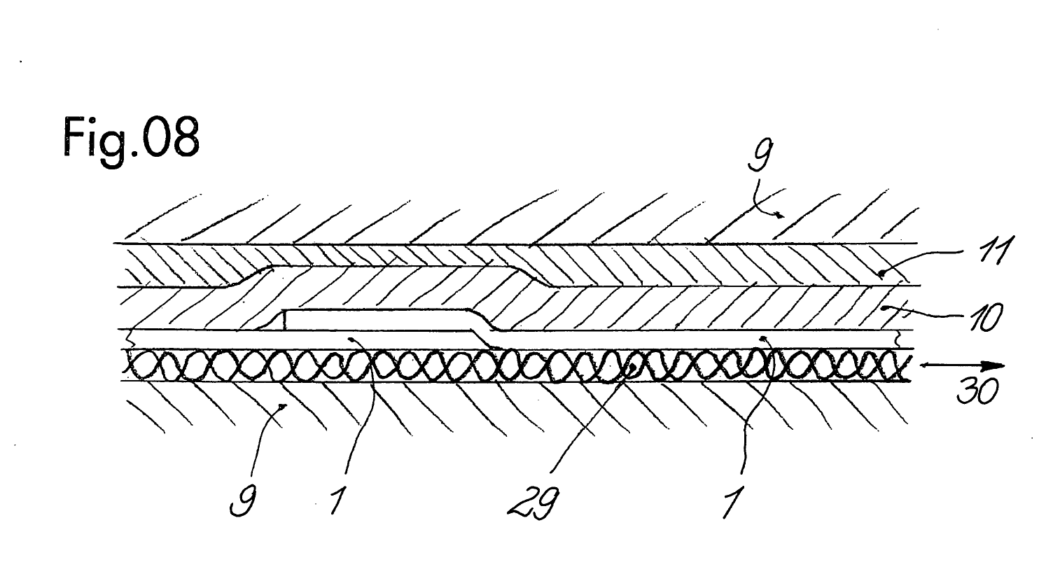

### FIGS. 07 and 08

A wood block (22) of beech is milled smooth at a slanted surface (23) where the veneer slicing knife (26) later on will penetrate into the wood block, is briefly heated by means of heat radiators (24), and immediately subsequently thereto is coated with a melamine resin glue (25). By heating, the surface of the block that has a moisture of 80% dries so that the application of the glue and immediate drying are possible. Subsequently, the veneer is sliced from the wood block (22) and its longitudinal edges (11) already have a slanted edge (8) with applied glue. These veneer sheets, as explained in connection with Example 3, are glued to each other wherein the rigid press platen (9) is covered with a tight mesh Flexoplan screen (29) that is conventional in chipboard manufacture. This screen enables partial escape of water vapor (30) that is produced during pressing of the moist veneer to the exterior. In this way, the veneer during pressing is dried to a wood moisture content of 20%.

The further processing of the pressed veneer strip corresponds to that of Example 3 with the exception of the changed wood moisture. The undulation that occurs after drying in particular for the wood type beech is not yet distinct for a wood moisture content of 20% so that a pass through the grinding machine is possible without damages in the form of cracks. During grinding and further transport, the veneer will release approximately 4% of moisture and is then glued with approximately 16% to both faces of the chipboard. The increased wood moisture prevents possible cracks in the veneer strip during pressing onto the chipboard and furthermore, a slightly increased yield as a result of reduced shrinkage of the veneer is observed.

### EXAMPLE 5

In analogy to Example 1, a veneered board is produced wherein however undried beech veneer of a wood moisture of approximately 80% is used. For gluing of the moist veneer a two-component polyurethane glue is used at a pressing temperature of 80 degrees Celsius. The wood moisture is partially introduced into the board during pressing, partially it escapes from the hot veneer directly to the exterior after opening the press. In comparison to Example 1, advantages are the elimination of the separate working step of drying as well as the avoidance of cracks caused by undulations.

### EXAMPLE 6

An oak veneer strip of a thickness of 1.5 mm is produced as described in Example 4 and is glued to one side of a medium-density fiberboard having a thickness of 10 mm and finished; onto the opposite side conventionally joined, 1.5 mm thick peeled beech veneer is applied with known press platens. The board veneered in this way is used for producing prefabricated parquet flooring elements.

### EXAMPLE 7

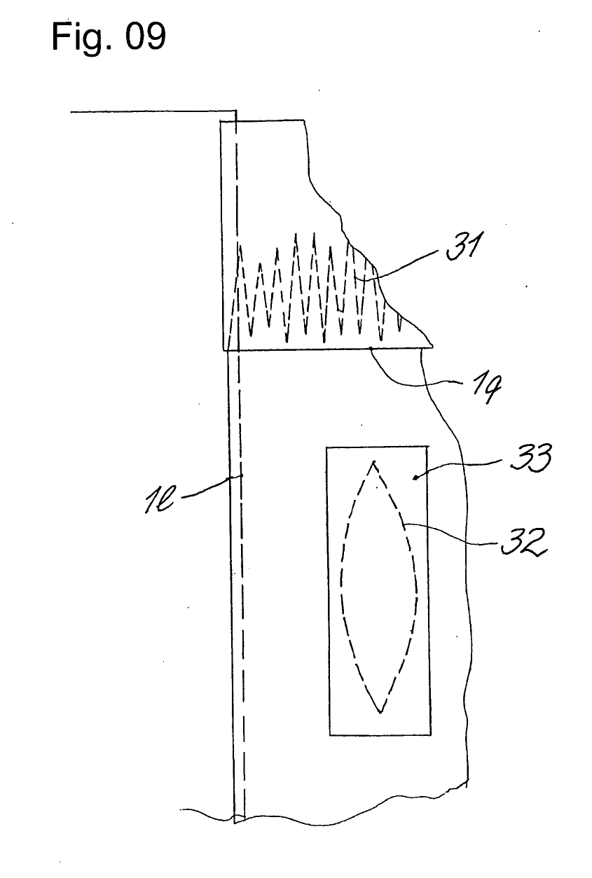

### FIG. 09

A veneered board according to Example 1 is produced wherein the veneers are not only placed in overlapped arrangement onto the longitudinal edges (1l) having a length of 2,400 mm but also, depending on the yield of shorter veneer pieces, along the transverse edges (1q) having a width of 150 mm. The transverse edges (1q) positioned underneath are formed with a known finger joint stamping tool in a zigzag shape (31). Upon pressing the veneer, the press pad follows the zigzag contour as well as the longitudinal edges (1l) so that all joints are tightly compressed.

Wood flaws such as knots are stamped out with a circulating stamping tool that tapers at the edges to a point and subsequently are covered with a veneer piece (33) that covers the stamped-out portion (32). During pressing, this contour is also tightly compressed. The further processing of the board corresponds to that of Example 1.

Advantageously, the possibility of use of otherwise unusable residual pieces is provided. By stamping out locally limited wood flaws, large-size veneer sheets can be processed to as a whole without having to split them to smaller sizes because of individually occurring wood characteristics.

### EXAMPLE 8

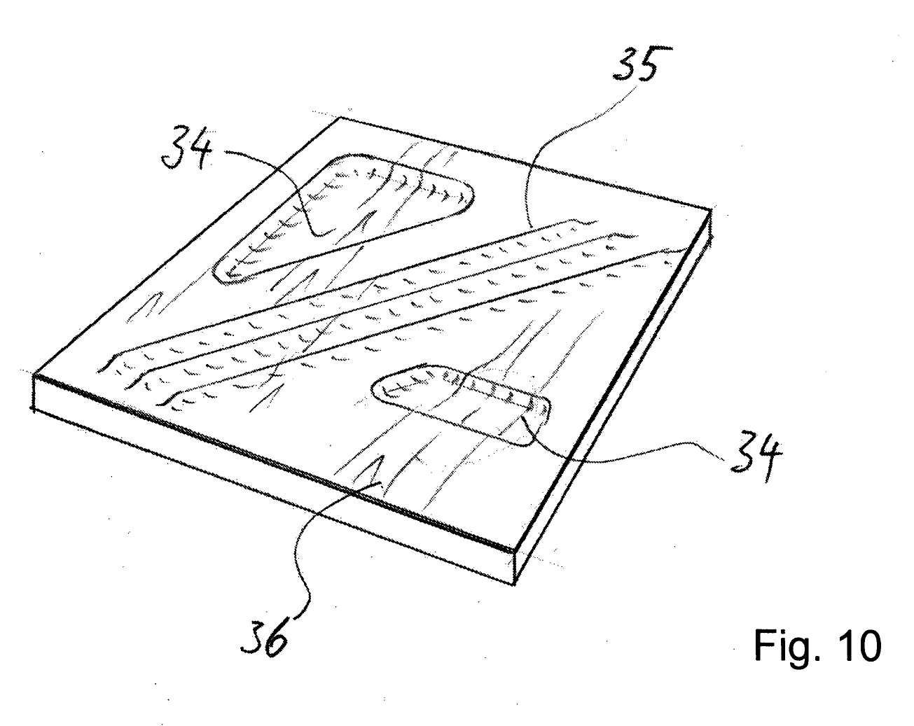

### FIG. 10

A veneer strip produced in accordance with Example 3 is glued by means of a press pad disclosed in Example 1 onto an MDF support component coated with PVAc glue. This support component is provided with milled decorative portions of a depth of 1.5 mm and is provided in other areas with 1 mm thick decorative applications of plastic strands. The press pad conforms to the depressions (34) and projections (35) of the support components and presses the veneer strip (36) in all areas true to the contour and with uniform pressing force. In this way, a decorative furniture part is produced.

### EXAMPLE 9

In analogy to Example 1, onto a chipboard of 19 mm thickness, 0.6 mm thick oak veneer sheets with a length of 700 mm and a width of 100 mm are glued in overlapped arrangement, wherein the overlap width is uniformly 15 mm. The longitudinal edges of the veneer sheets are cut straight. In contrast to Example 1 the overlapped areas are not ground but together with the other surface areas are only smoothed by means of grinding tools that are adjustable with respect to height. The thus produced surface profile serves as a decorative directionally emphasized surface for interior elements.

### OVERVIEW OF THE EMPLOYED REFERENCE CHARACTERS

1 veneer sheet
1l longitudinal edge of the veneer sheet
1q transverse edge of the veneer sheet
2 transition area
3 visible surface
4 wedge-shaped joint
5 tight joint
6 support
7 overlap
8 bevel
9 press platen
9o top press platen
9u bottom press platen
10 mat
11 plastic mass
12 profile corner
13 wedge-shaped displacement
14 veneer stack
15 bending device
16 slanted fanned ends of the veneer sheets
17 milling tool
18 glue application roller
19 initial position of the veneer stack
22 wood block
23 slanted surfaces of the wood block 23
24 heat radiator
25 melamine glue layer
26 knife
27 veneer sheet being produced with slanted longitudinal edge edge 1l with applied glue
29 Flexoplan screen
30 escaping water vapor
31 shaped part
32 stamped-out part
33 covering veneer piece

What is claimed is:

1.-10. (canceled)

11. A veneer strip, comprised of veneer sheets (1) with an average thickness of 0.2 mm to 2.5 mm, wherein neighboring veneer sheets (1), respectively, are connected to each other by a glue in the transition area (2) while overlapping at the visible surface (3) and forming a tight joint (5) and, in the area underneath, forming a joint (4) that is wedge-shaped in cross-section and filled with glue.

12. The veneer strip according to claim 11, wherein the glue is a curing glue.

13. The veneer strip according to claim 12, wherein the glue is selected from the group consisting of urea-formaldehyde resin glue, melamine glue, PVAc glue, and PUR glue.

14. The veneer strip according to claim 11, wherein transverse edges (1q) of the respective underlying veneer sheet (1) has cuts or cutouts.

15. The veneer strip according to claim 14, wherein the cuts have a zigzag-shaped course.

16. The veneer strip according to claim 11, wherein at least one of the longitudinal and transverse edges (1l, 1q) of the veneer sheet (1) is slanted or has a bevel (8).

17. A method for producing closed veneer strips according to claim 11, comprising:
providing individual veneer sheets (1) having a thickness of 0.2 mm to 2.5 mm with glue at longitudinal and/or transverse edges (1l, 1q);
positioning the veneer sheets scale-like and overlapped such that, in the upper area, the veneer sheets form a tight first joint (5) and, in the area underneath, the veneer sheets form a second joint (4) that in cross-section is wedge-shaped and filled with glue;
pressing the veneer sheets under pressure; and
milling and/or grinding subsequently the visible surface (3) of the veneer sheets.

18. The method according to claim 17 for producing multi-layered closed veneer strips, wherein several closed veneer strips are connected to each other by glue and pressure application.

19. The method according to claim 18, wherein positioning and adaptation of the veneer strip on the support (6) is realized under pressure and at a pressing temperature of 20 degrees Celsius to 150 degrees Celsius.

20. The method according to claim 19 for producing closed, single-layer veneer strips, in which flawed areas of the veneer sheet are eliminated in that the transverse edges (1q) or openings (32) are shaped with a stamping tool and subsequently covered by a covering veneer piece (33) and pressed.

21. The method according to claim 17 for producing closed, single-layer veneer strips, in which flawed areas of the veneer sheet are eliminated in that the transverse edges (1q) or openings (32) are shaped with a stamping tool and subsequently covered by a covering veneer piece (33) and pressed.

22. The method according to claim 17, wherein positioning and adaptation of the veneer strip on the support (6) is realized under pressure and at a pressing temperature of 20 degrees Celsius to 150 degrees Celsius.

23. A device for performing the method according to claim 17, comprising a press pad for positioning and adaptation of the veneer strip on the support (6), wherein the press pad is made of a soft stretchable mat (10) and a layer of a plastic mass (11) positioned there behind that reaches its plasticity at the respectively adjustable pressing temperature.

24. A veneer strip according to claim 11 in the form of a veneered component for producing furniture, doors, wall panels, interior work elements, parquet elements, vehicle installations, or casings of any kind.
